(19) United States
(12) Patent Application Publication
(10) Pub. No.: US 2017/0009957 A1
(43) Pub. Date: Jan. 12, 2017

(54) LINEAR LED LIGHTING SYSTEM WITH CONTROLLED DISTRIBUTION

(71) Applicant: Cree, Inc., Durham, NC (US)

(72) Inventors: Jin Hong Lim, Cary, NC (US); P. Joseph DeSena, JR., Raleigh, NC (US); Bernd R. Sieberth, Salem, WI (US); Michael Hash, State College, PA (US); Kurt Wilcox, Libertyville, IL (US); Johan Samuelsson, Raleigh, NC (US); Yaote Huang, Morrisville, NC (US)

(21) Appl. No.: 14/795,182

(22) Filed: Jul. 9, 2015

(51) Int. Cl. F21V 7/06; F21V 19/00; F21V 23/02; F21V 3/04; F21K 99/00

(52) U.S. Cl. CPC F21V 7/06; F21V 3/049; F21K 9/54; F21V 23/02; F21V 19/003; F21Y 2103/003

(57) ABSTRACT

A linear LED lighting system, assembly and/or fixture distributes luminance efficiently in certain applications, such as for ceiling lighting used in certain retail environments. According to example embodiments of the invention, a linear LED lighting system includes at least two tilted, parabolic reflecting surfaces and a linear array of LED devices, wherein at least some of the LED devices are substantially disposed at a focus line of at least one of the tilted, parabolic reflecting surfaces. A diffuser or diffusive lens can be disposed adjacent to the parabolic reflecting surfaces where light exits the system to provide color mixing and/or eliminate potential hot spots. The tilt of the reflecting surfaces can be changed to adjust the illumination pattern. A lighting system according to example embodiments of the invention can be designed for retrofit installation or as a complete fixture.

### BACKGROUND

Light emitting diode (LED) lighting systems are becoming more prevalent as replacements for legacy lighting systems. LED systems are an example of solid state lighting (SSL) and have advantages over traditional lighting solutions such as incandescent and fluorescent lighting because they use less energy, are more durable, operate longer, can be combined in multi-color arrays that can be controlled to deliver any color light, and generally contain no lead or mercury. A solid-state lighting system may take the form of a luminaire, lighting unit, light fixture, light bulb, or a “lamp.”

An LED lighting system may include, for example, a packaged light emitting device including one or more light emitting diodes (LEDs), which may include inorganic LEDs, which may include semiconductor layers forming p-n junctions and/or organic LEDs, which may include organic light emission layers. Light perceived as white or near-white may be generated by a combination of red, green, and blue (“RGB”) LEDs. Output color of such a device may be altered by separately adjusting supply of current to the red, green, and blue LEDs. Another method for generating white or near-white light is by using a lumiphor such as a phosphor. Still another approach for producing white light is to stimulate phosphors or dyes of multiple colors with an LED source. Many other approaches can be taken.

An LED lamp may be made with a form factor that allows it to replace a standard incandescent bulb, or any of various types of fluorescent lamps. LED lamps often include some type of optical element or elements to allow for localized mixing of colors, collimate light, or provide a particular light pattern. Sometimes the optical element also serves as an enclosure for the electronics and/or the LEDs in the lamp.

LED lighting systems may also be designed in the form of a larger light fixture, such as those that may be used in commercial and retail environments. Such a lighting system may be designed from scratch as an LED-based fixture. Alternatively such a lighting system may be designed for “retrofit” installation, to fit in the same space or re-use some of the components or connections of a traditional incandescent or fluorescent fixture. Since, ideally, an LED lamp designed as a replacement for a traditional incandescent or fluorescent light source needs to be self-contained; a power supply is included in the lamp, system, or fixture along with the LEDs or LED packages and the optical components.

FIG. 1 and FIG. 2 illustrate a perspective view and a cross-sectional view, respectively, of an existing LED lighting system, 100. System 100 includes mounting plate 102 to aid in retrofitting existing light fixtures. A curved diffuser 104 encloses a circuit board 106 with two rows of LEDs disposed in a linear array, row 110 and row 112. FIG. 3 illustrates the illumination pattern 302 from the lighting system of FIG. 1 and FIG. 2. In this particular example, the fixture is installed on a ceiling in between tall, retail store racks 320. The illumination pattern causes light to be dispersed on the top of the racks, over the entire face of each rack, and on the floor.

### SUMMARY

Embodiments of the present invention provide LED lighting systems, assemblies and/or fixtures that distribute illuminance efficiently in certain applications, such as for ceiling lighting used in large retail environments. According to example embodiments of the invention, a linear LED lighting system includes at least two tilted, parabolic reflecting surfaces and a linear array of LED devices, wherein at least some of the LED devices are substantially disposed at a focus line of at least one of the tilted, parabolic reflecting surfaces. A diffuser or diffusive lens can be disposed adjacent to the parabolic reflecting surfaces so that light exits the system through the diffuser to provide color mixing and/or eliminate hot spots. In some embodiments, the diffuser is connected to the parabolic reflecting surfaces by a tab and slot arrangement. In some embodiments, the diffuser provides from 10% to 15% diffusion, for example, by being frosted or roughened. The linear array of LED devices can include a single row of LED devices or multiple rows of LED devices.

In some embodiments, a solid-state lighting system includes two tilted, parabolic reflecting surfaces having a common focus line. A row of LED devices is disposed substantially on the common focus line of the two tilted, parabolic reflecting surfaces. A diffuser is disposed adjacent to the two tilted, parabolic reflecting surfaces opposite the row of LED devices. The lighting system or lighting assembly can be built as or into a light fixture. Alternatively, the system can include a mounting arrangement such as a mounting plate engageable with a portion of an existing fixture so that the lighting system can be used in retrofit applications. In some embodiments, the tilted, parabolic reflecting surfaces are tilted from 5 degrees to 9 degrees relative to the normal and may have a base separation of 49 mm. In some embodiments, the tilted, parabolic reflecting surfaces are tilted from 6 degrees to 8 degrees relative to the normal and may have a base separation of about 39 mm. In still other embodiments, the tilted, parabolic reflecting surfaces are tilted about 8 degrees relative to the normal and may have a base separation of about 30 mm. A product can be designed so that the tilt angle can be adjusted to a specified angle for a particular installation, either in the field or during manufacture and the separation may be adjusted as well to achieve the desired light pattern.

For retrofit installation, one or multiple lighting assemblies can be provided for use in replacing a portion of an existing fixture. For example, the lighting assembly or assemblies can be provided on a mounting plate that can be engaged with a portion of the existing fixture after the previous lighting devices have been removed and with instructions to direct the installation. The retrofit assemblies can be provided with an appropriate connection to a power source such as the AC-mains, which is then connected to provide power to the LED devices. Such a connection can be made through a power supply or driver that is part of or included with the lighting assembly.

### BRIEF DESCRIPTION OF THE DRAWINGS

FIG. 1 and FIG. 2 show different views of an existing solid-state lighting system.

FIG. 3 is a schematic illustration of the illumination pattern from the lighting system of FIGS. 1 and 2.

FIG. 4, FIG. 5, and FIG. 6 are different views of the light engine or optical portions of a lighting system according to example embodiments of the invention. FIG. 4 is a cross-sectional view, FIG. 5 is an exploded perspective view, and FIG. 6 is an exploded cross-sectional view.

FIG. 7, FIG. 8, FIG. 9, and FIG. 10 illustrate various views of a complete lighting system or lighting assembly according to example embodiments of the present invention. FIG. 7 is a perspective view, FIG. 8 is a cross-sectional view, FIG. 9 is an exploded perspective view, and FIG. 10 is an end view.

FIG. 11 is a schematic illustration of the illumination pattern from the lighting systems shown in FIG. 4 through FIG. 10.

FIG. 12, FIG. 13, and FIG. 14 are light ray diagrams that illustrate how the tilt angle of the parabolic reflecting surfaces in embodiments of the invention affect the illumination pattern of the lighting system.

FIG. 15 is a cross-sectional view of a lighting system according to an additional embodiment of the present invention.

FIG. 16, FIG. 17, and FIG. 18 are various views of a light fixture according to embodiments of the present invention. FIG. 16 is a bottom view, FIG. 17 is a longitudinal sectional view, and FIG. 18 is a cross-sectional view.

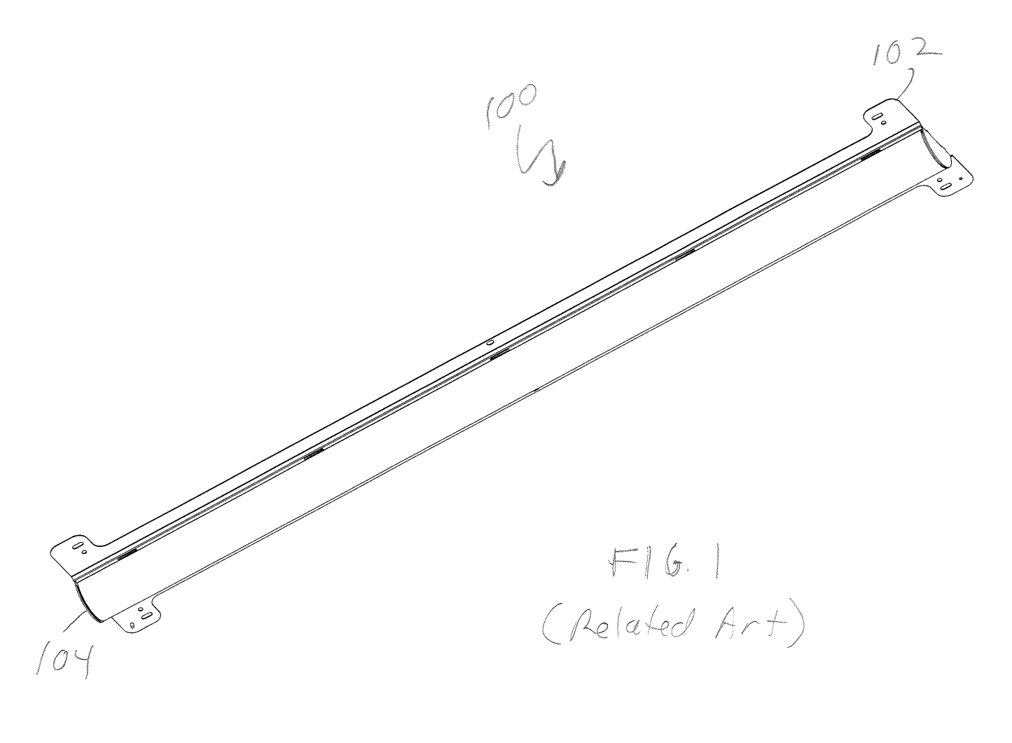

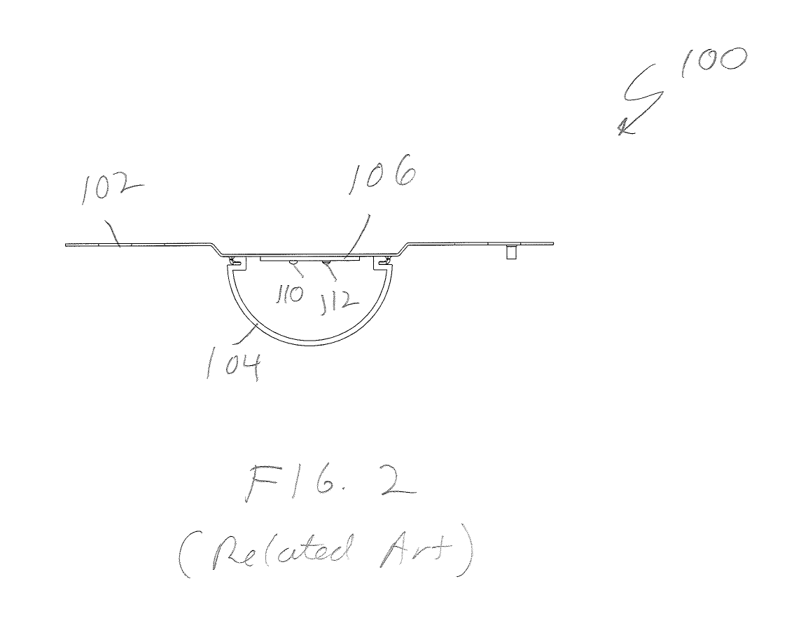

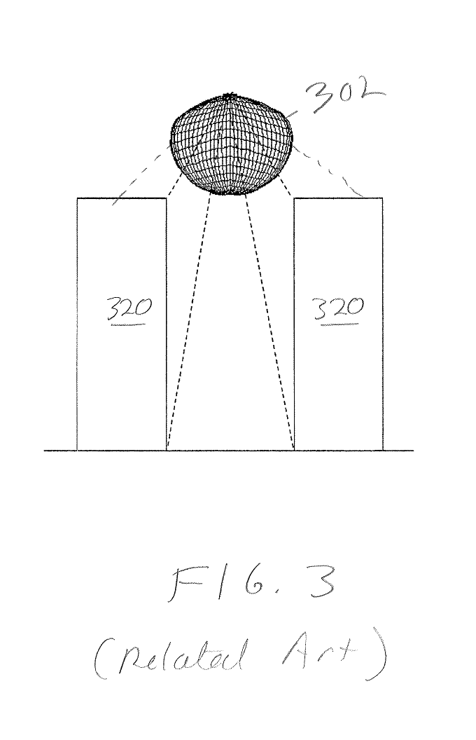

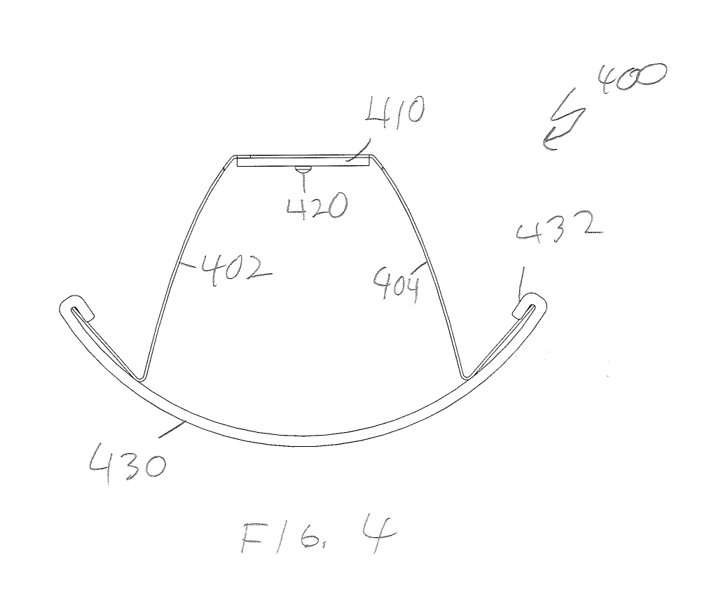

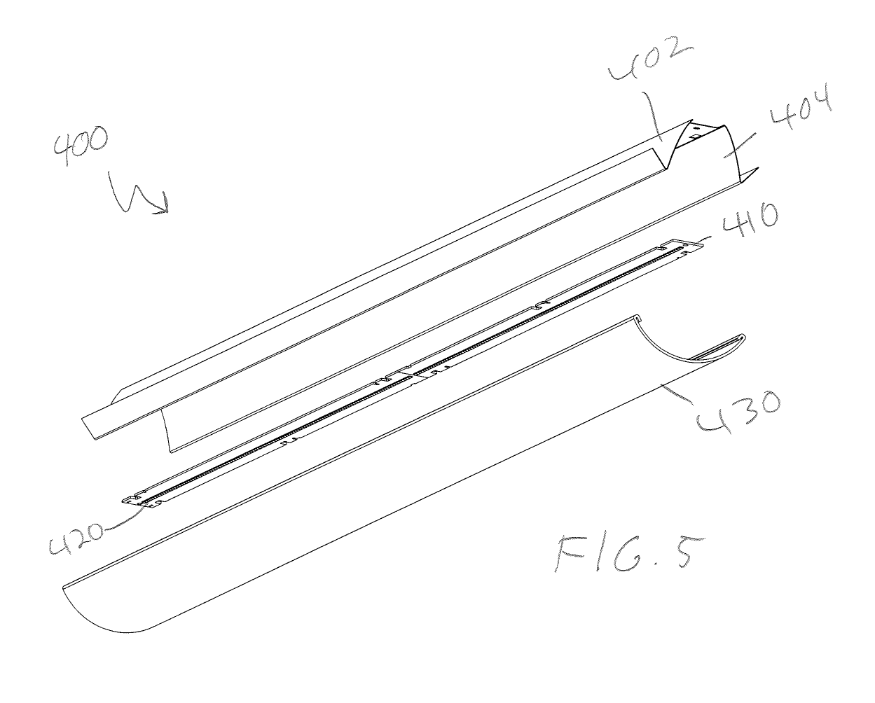

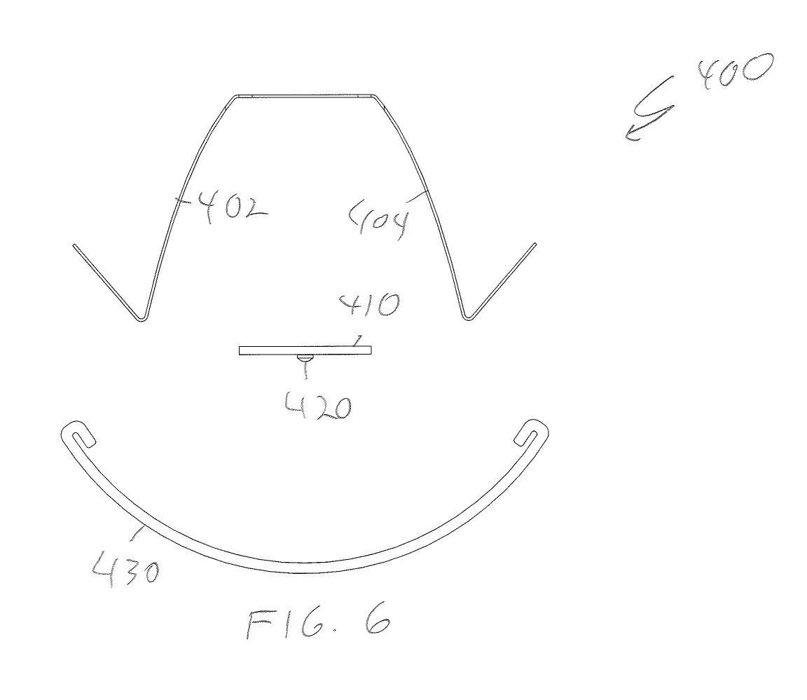

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

Unless otherwise expressly stated, comparative, quantitative terms such as “less” and “greater”, are intended to encompass the concept of equality. As an example, “less” can mean not only “less” in the strictest mathematical sense, but also, “less than or equal to.”

The terms “LED” and “LED device” as used herein may refer to any solid-state light emitter. The terms “solid-state light emitter” or “solid-state emitter” may include a light emitting diode, laser diode, organic light emitting diode, and/or other semiconductor device which includes one or more semiconductor layers, which may include silicon, silicon carbide, gallium nitride and/or other semiconductor materials, a substrate which may include sapphire, silicon, silicon carbide and/or other microelectronic substrates, and one or more contact layers which may include metal and/or other conductive materials. A solid-state lighting device produces light (ultraviolet, visible, or infrared) by exciting electrons across the band gap between a conduction band and a valence band of a semiconductor active (light-emitting) layer, with the electron transition generating light at a wavelength that depends on the band gap. Thus, the color (wavelength) of the light emitted by a solid-state emitter depends on the materials of the active layers thereof. In various embodiments, solid-state light emitters may have peak wavelengths in the visible range and/or be used in combination with lumiphoric materials having peak wavelengths in the visible range. Multiple solid-state light emitters and/or multiple lumiphoric materials (i.e., in combination with at least one solid-state light emitter) may be used in a single device, such as to produce light perceived as white or near-white in character. In certain embodiments, the aggregated output of multiple solid-state light emitters and/or lumiphoric materials may generate warm white light output having a color temperature range of from about 2700K to about 4000K.

Solid-state light emitters may be used individually or in combination with one or more lumiphoric materials (e.g., phosphors, scintillators, lumiphoric inks) and/or optical elements to generate light at a peak wavelength, or of at least one desired perceived color (including combinations of colors that may be perceived as white). Inclusion of lumiphoric (also called ‘luminescent’) materials in lighting devices as described herein may be accomplished by direct coating on solid-state light emitter, adding such materials to encapsulants, adding such materials to lenses, by embedding or dispersing such materials within lumiphor support elements, and/or coating such materials on lumiphor support elements. Other materials, such as light scattering elements (e.g., particles) and/or index matching materials may be associated with a lumiphor, a lumiphor binding medium, or a lumiphor support element that may be spatially segregated from a solid-state emitter.

It should also be noted that the term “lamp” is meant to encompass not only a solid-state replacement for a traditional incandescent bulb as illustrated herein, but also replacements for fluorescent bulbs, replacements for complete fixtures, and any type of light fixture that may be custom designed as a solid state fixture.

The term “LED lighting system” or the term “solid-state lighting system” as used herein can refer to a fixture, an assembly, a light engine, or any other solid-state lighting arrangement. The term “LED lighting assembly” is meant to refer to a portion of a fixture that includes a light engine or light basket. For example, this term could be used to refer to an assembly that is provided to engage with a portion of a pre-existing fixture to allow retrofitting of solid-state lighting with minimal effort. Terms such as “fixture” or “light fixture” are intended to have their conventional meaning as is known within the architectural lighting arts. The term “mounting arrangement” in the context of the present disclosure is intended to refer to hardware and/or components that enable a lighting assembly to be used in a retrofit application. For example, the mounting arrangement could include a mounting plate with appropriate tabs, holes, or the like to engage with a portion of a pre-existing light fixture.

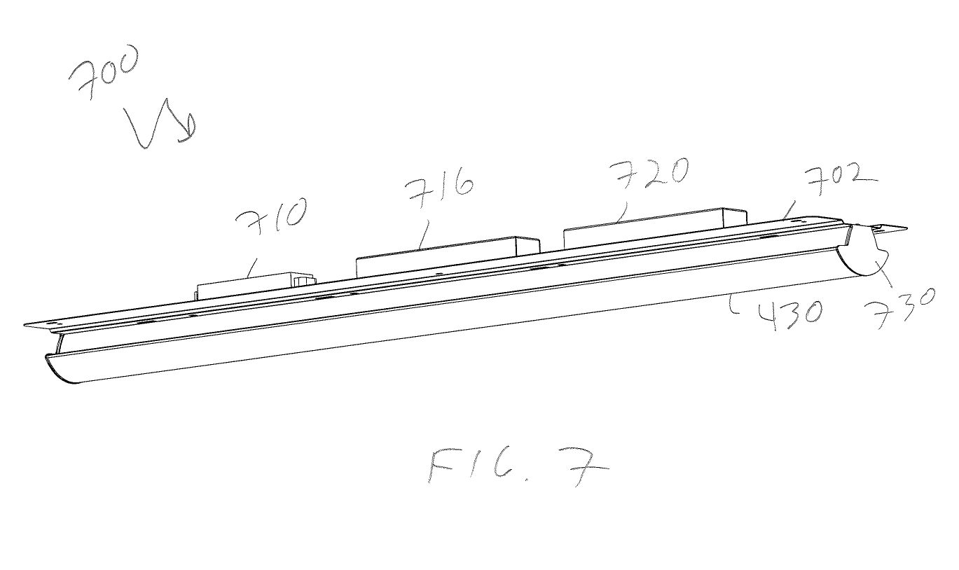

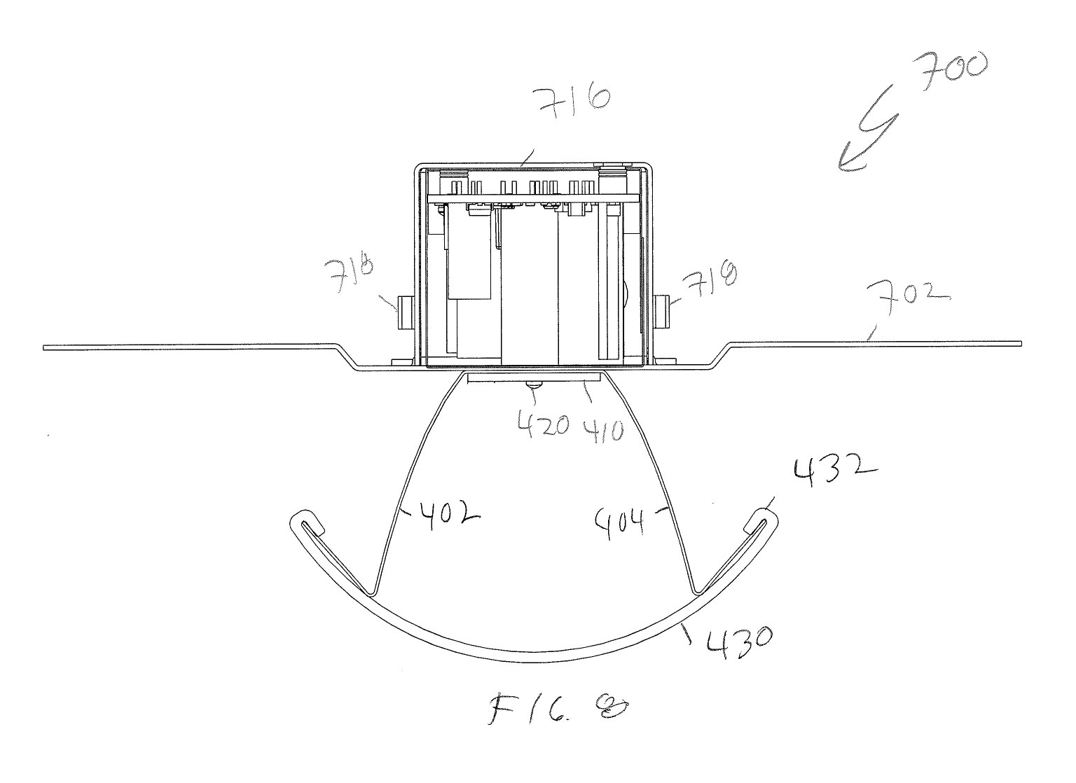

FIG. 4, FIG. 5, and FIG. 6 show differing views of a lighting system, more specifically the light engine, according to embodiments of the present invention. FIG. 4 is a cross-sectional view, FIG. 5 is an exploded perspective view, and FIG. 6 is an exploded cross-sectional view. Lighting system 400 includes two, tilted, parabolic reflecting surfaces, 402 and 404. A circuit board, 410, has a linear array of LED devices 420 mounted thereon. A diffuser 430 is disposed adjacent to the two tilted, parabolic reflecting surfaces so that light exits the system through the diffuser. The parabolic reflecting surfaces may be or may be referred to as “reflectors.” In this particular example embodiment, these reflectors are joined together across the top of the light basket under the circuit board. Thus, they are formed from a single piece of plastic or metal for ease of assembly. However, two separate reflectors could be used.

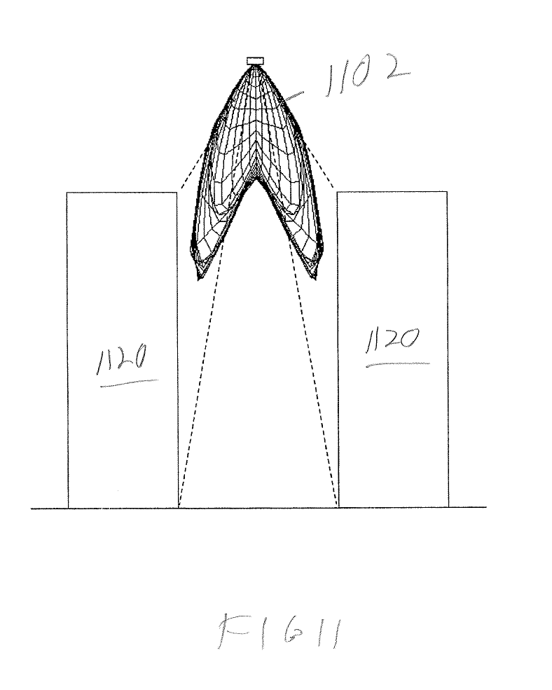

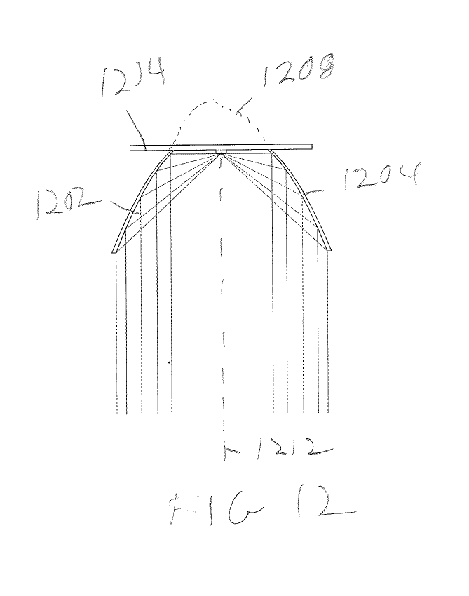

Diffuser 430 may be made of plastic, glass, or other materials. In example embodiments, the diffuser is made of polycarbonate, acrylic or similar plastic with a frosted surface having between 10% and 15% frosting or other treatment to cause from 10% to 15% diffusion of light exiting the light engine. Diffuser 430 is fastened to the reflectors (the reflecting surfaces) in example system 400 by a force-fit tab and slot arrangement 432 as shown. The “tilted” nature of the reflecting surfaces and its effect on the illumination pattern of a lighting system will be discussed in detail with respect to FIGS. 11 through 14. However, for purposes of the present discussion, the row of LED devices is disposed on focus line that is common for each tilted, parabolic reflecting surface.

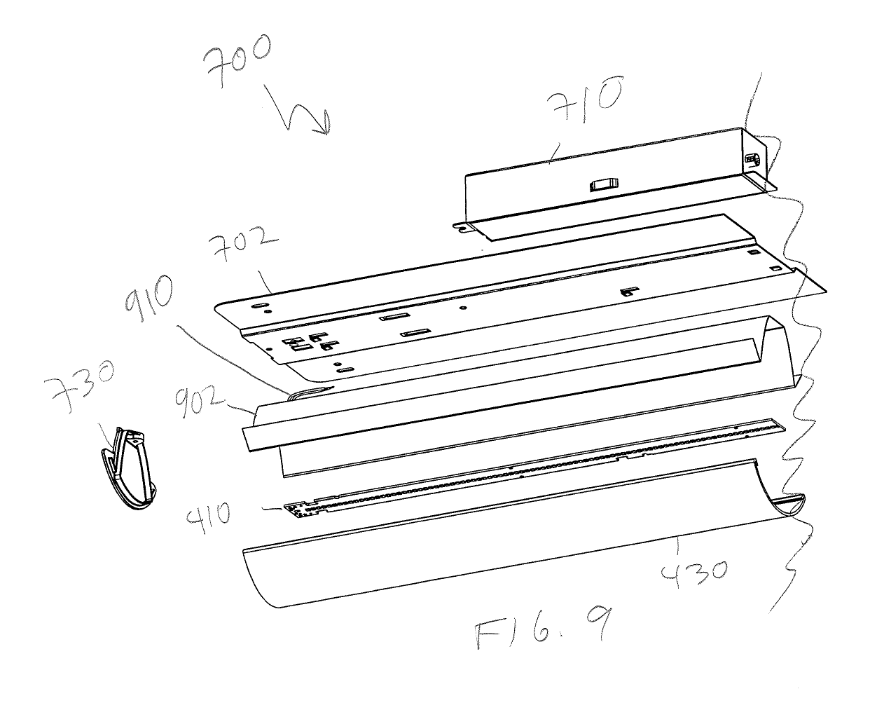

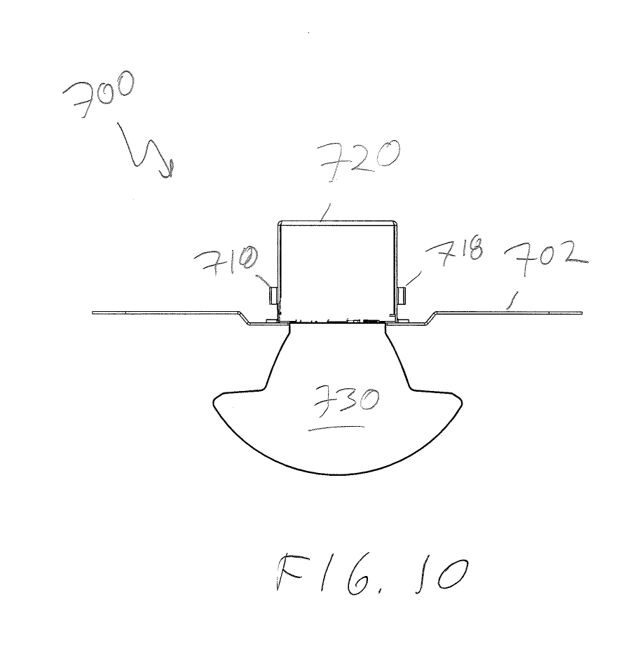

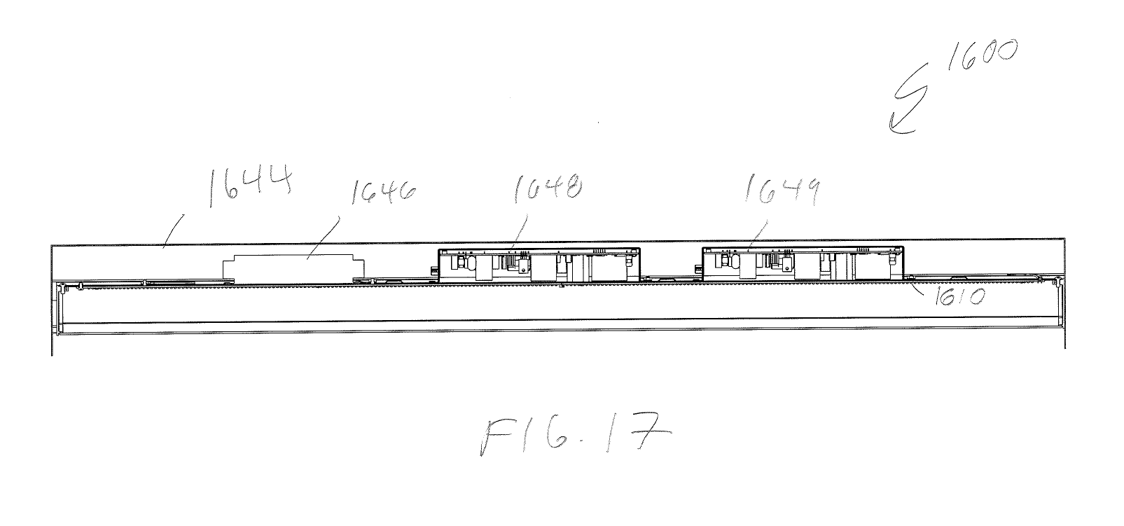

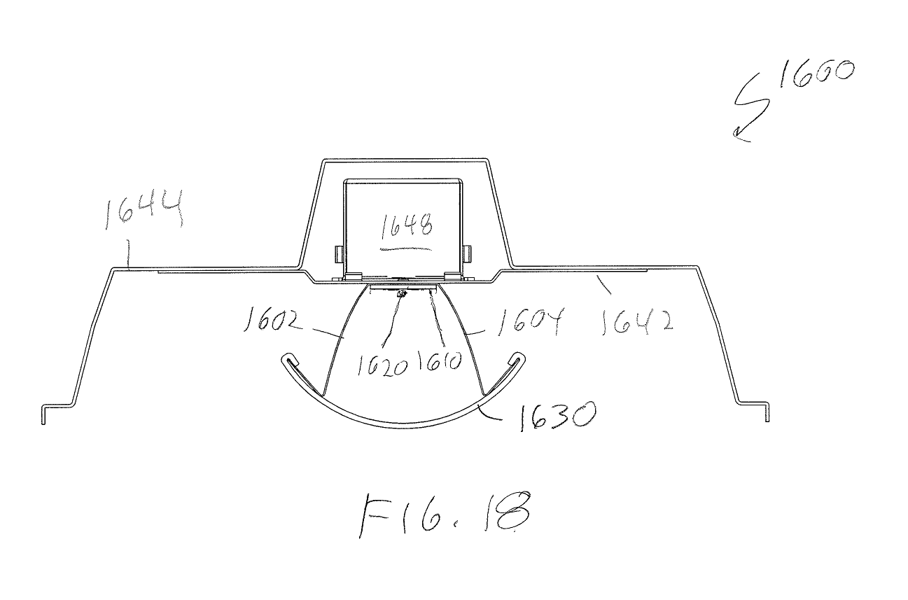

FIG. 7, FIG. 8, FIG. 9, and FIG. 10 show various views of an LED lighting assembly, 700, according to example embodiments of the present invention. FIG. 7 is a perspective view, FIG. 8 is a cross-sectional view, FIG. 9 is an exploded perspective view of a portion of the assembly, and FIG. 10 is an end view of the assembly. LED lighting assembly 700 makes use of the light engine already described. Like numbers refer to like elements. In this case, the lighting assembly includes mounting arrangement 702, which is a mounting plate with appropriate screw holes, etc. to be engageable with at least a portion of a pre-existing light fixture. The plate can also serve as a heatsink. The use of an embodiment of the invention in a complete light fixture with be further discussed later with respect to FIGS. 16-18.

Assembly 700 of FIGS. 7, 8, 9, and 10 also includes electronics and power supply components in circuit boxes 710, 716, and 720. Electronic components are visible in the cross-section of FIG. 8, along with fasteners 718 to hold the circuit together. Circuit boxes 710, 716, and 720 house electronics used to drive and control the LED devices such as rectifiers, regulators, timing circuitry, and other components. Lighting assembly 700 includes two identical end caps, 730, to enclose the light basket of the lighting assembly. As is readily visible in FIG. 9, the parabolic reflecting surfaces or reflectors are formed as a single reflector assembly 902. Additionally, the power supply or power supplies are connected to the LED devices 420 through cable 910.

FIG. 11 illustrates the illumination pattern 1102 from the lighting system of FIGS. 4-10. The lighting system is installed on a ceiling in between tall, retail store racks 1120. The illumination pattern causes light to be dispersed downward, towards the floor and the lower portions of the retail racks. Little to no light spills onto the top of racks 1120. Such an illumination pattern eliminates wasted light and can be especially advantageous in so-called “big box” or “warehouse” stores with very high racks, where customers typically only access the lower 6-8 feet of shelf space.

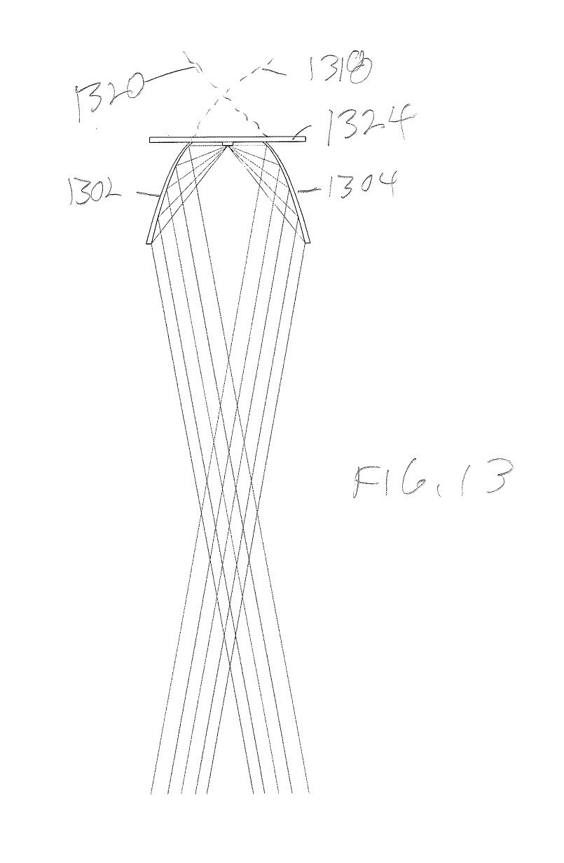

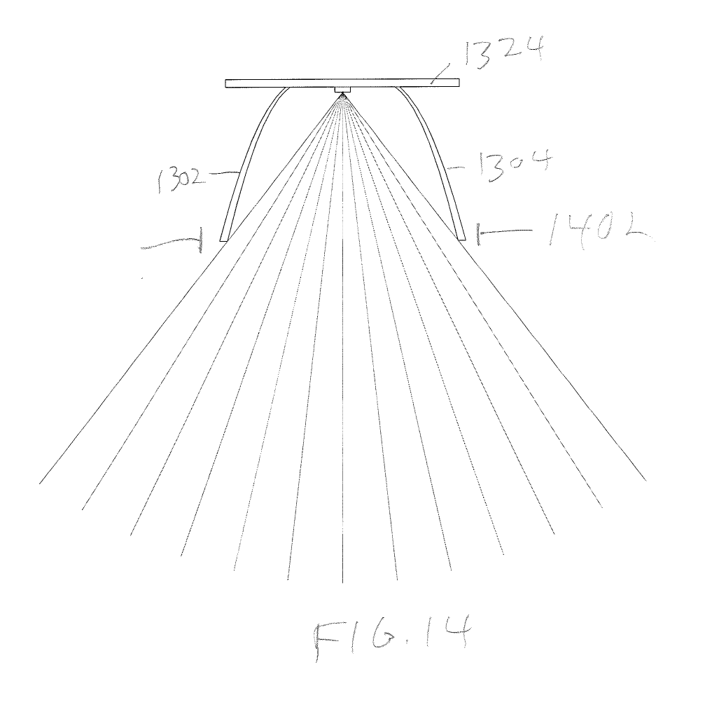

FIGS. 12, 13, and 14 are useful in explaining how the light pattern described above is achieved with the lighting system heretofore described. FIG. 12 illustrates a cross-section of two cylindrical, parabolic reflecting surfaces 1202 and 1204, which mathematically, follow the same parabolic curve, as illustrated by parabolic line 1208. Line 1212 bisects the parabolic surface and divides it in half, and may be referred to as “the normal” or the normal line of the parabolic surface. This line is positioned at a normal angle relative to surface 1214, on which a light source might be placed at a focus point, or multiple line sources might be linearly arranged on a “focus line” of the cylindrical parabolic surface. As is apparent from the light ray tracings in FIG. 12, the parabolic surfaces cause some light from the source to be directed straight downward.

FIG. 13 schematically illustrates what is meant by “tilted” parabolic reflecting surfaces having a common focus line, as described in reference to the lighting systems of FIGS. 4-10. Reflectors 1302 and 1304 are tilted towards the normal, and in fact no longer mathematically follow the same parabolic curve, but rather independently follow two different curves 1318 and 1320 (exaggerated for clarity). However these curves have the same curvature and focus line which is positioned on surface 1324. This tilt causes the light to be diverted to the sides as shown by the light ray tracings of FIG. 13. The illumination pattern of the lighting systems described herein can be altered by altering the tilt of the parabolic surfaces. It has been found that an advantageous tilt angle for large retail spaces as previously described is about 8 degrees inward relative to and towards the normal. In some embodiments, the tilted, parabolic reflecting surfaces are tilted from 5 degrees to 9 degrees relative to the normal and have a base separation of 49 mm. In some embodiments, the tilted, parabolic reflecting surfaces are tilted from about 6 degrees to about 8 degrees relative to the normal and have a base separation of about 39 mm, or about 8 degrees relative to the normal with a base separation of about 30 mm. In some embodiments, the tilt of the reflectors is from about 5 degrees to about 10 degrees. In some embodiments, the tilt of the reflectors is from about 4 degrees to about 12 degrees, and base separation can vary.

FIG. 14 illustrates the same surfaces shown in FIG. 13. In this case, the light ray tracings for light that does not strike the tilted parabolic, reflecting surfaces are shown. If the tilt of the reflecting surfaces is changed, the opening 1402 changes size, which also affects the illumination pattern of the lighting system. Thus, one who is customizing or designing a lighting system as described herein needs to take both sets of light rays into account in making adjustments to the tilt of the reflectors to achieve a specific illumination pattern. It should be noted that lighting systems according to example embodiments disclosed herein can be designed so that easy adjusting of the tilt angle of the two tilted, parabolic reflecting surfaces for different applications is supported. This could be done when an assembly or fixture is manufactured, or the system could be designed to allow change in the field.

In example embodiments, the base of the two reflecting surfaces near the linear LED array is separated by a distance (base separation) of from 25 mm to 45 mm, with best performance for a single row of LED devices being at about 30 mm and about 39 mm. Each reflector has a height of about 38 mm. As described thus far, the two reflectors in embodiments of the invention control the light direction symmetrically; however, different illumination patterns can be achieved by individually adjusting the tilt angle or height of each parabolic reflecting surface to cause the light to be in effect thrown to one side. Thus, the light direction can be controlled symmetrically or asymmetrically. An asymmetrical arrangement may be desirable in, for example, sign or art illumination, or for wall displays in otherwise open rooms. Regardless of whether the tilt is symmetrical, light rays from open portions of both reflectors contribute to the floor and shelf or wall illumination simultaneously, which creates a smooth variation in lighting.

The diffuser lens creates smooth variation in lighting and reduces pixilation and hot spots, which is desirable for practical applications. In some embodiments, Rotuba™ ZDF24 10% to 15% frosted acrylic has been used for the diffusive lens, and each reflector has a specular reflectivity of at least 94%. The diffuser lens in some embodiments has a curvature equal to a radius of about 55 mm. A system with reflector sizes and specularity as described above with a 6-8 degree tilt and this type of lens has been found to have an optical efficiency of at least 91%.

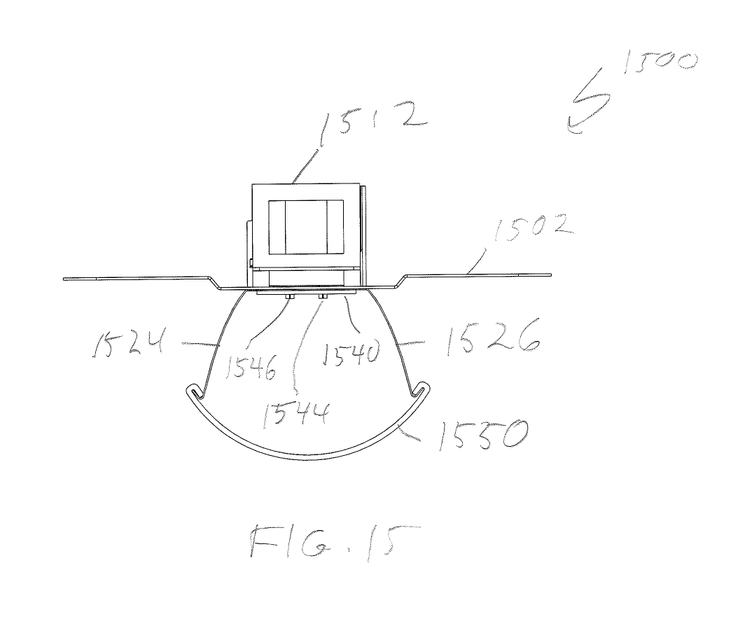

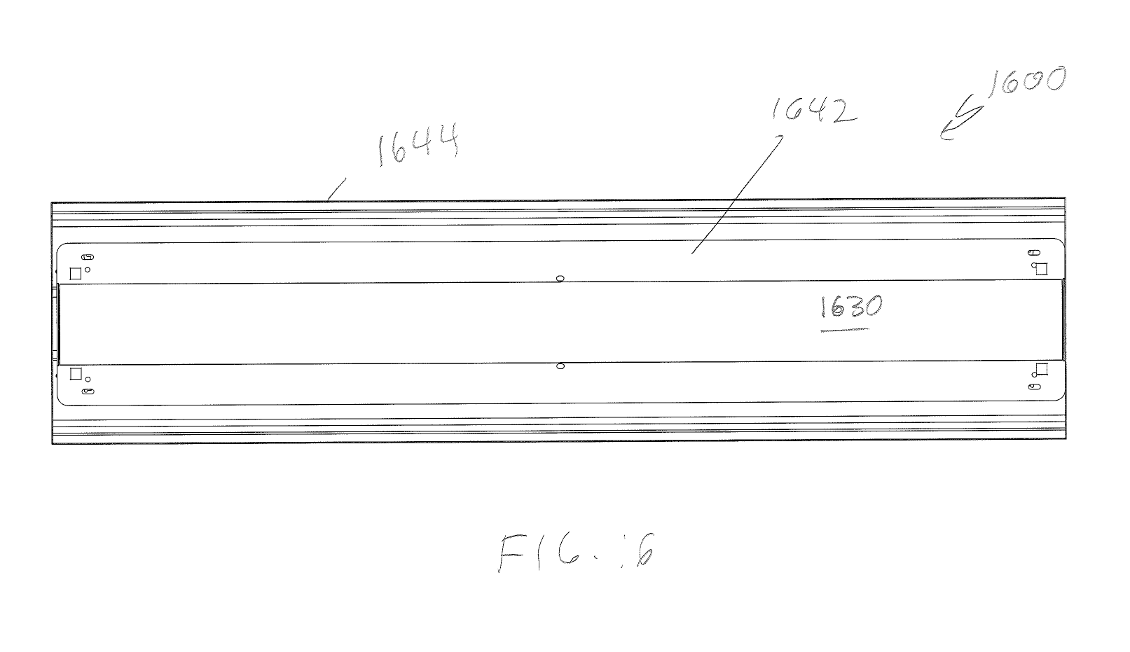

FIG. 15 is a cross-sectional view of an LED lighting assembly according to additional embodiments of the invention. In this case, the lighting assembly 1500 includes mounting arrangement 1502, which is again a mounting plate engageable with other portions of a light fixture. Assembly 1500 of includes electronics and power supply components in circuit box 1512. Parabolic reflecting surfaces or reflectors 1524 and 1526 are formed as a single reflector assembly. In this particular example embodiment, a circuit board, 1540, has two linear arrays of LED devices mounted thereon. The linear arrayed LEDs are located on the focal plane of the parabolic reflecting surfaces. One array is made up of LED devices 1544 and the other is made of LED devices 1546. As before, a diffuser 1550 is disposed adjacent to the two tilted, parabolic reflecting surfaces so that light exits the system through the diffuser. With lighting assembly 1500, each row of LED devices is disposed at the focus line of its respective tilted, parabolic reflecting surface, so that each row is at the focus line of one of the tilted, parabolic reflecting surfaces. In order to separate the focus lines of the two reflective surfaces, the surfaces need to be farther apart than the reflectors for an otherwise identical system with only a single row of LED devices, with the distance dictated in part by the distance between the rows of LED devices.

FIGS. 16, 17, and 18 are different views of a light fixture 1600 according to example embodiments of the present invention. FIG. 16 is a bottom view, FIG. 17 is a longitudinal sectional view and FIG. 18 is a cross-sectional view. Fixture 1600 includes two, tilted, parabolic reflecting surfaces, 1602 and 1604. A circuit board, 1610, has a linear array of LED devices 1620 mounted thereon. A diffuser 1630 is disposed adjacent to the two tilted, parabolic reflecting surfaces so that light exits the system through the diffuser. Diffuser 1630 may be made of plastic, glass, or other materials as previously discussed. The light fixture includes mounting plate 1642 and housing 1644. Mounting plate 1642 may serve as a heatsink. Fixture 1600 includes electronics and power supply components in circuit boxes 1646, 1648, and 1649. The circuit boxes house electronics used to drive and control the LED devices such as rectifiers, regulators, timing circuitry, and other components. Plate 1642 and housing 1644 may be enameled white on the inside or otherwise made reflecting to enhance the light output of the fixture and provide a traditional overall appearance.

The various portions of a fixture, assembly, or lighting system according to example embodiments of the invention can be made of any of various materials. Heatsinks can be made of metal or plastic, as can the various portions of the housings for the components of a lamp. A system according to embodiments of the invention can be assembled using varied fastening methods and mechanisms for interconnecting the various parts. For example, in some embodiments locking tabs and holes can be used. In some embodiments, combinations of fasteners such as tabs, latches or other suitable fastening arrangements and combinations of fasteners can be used which would not require adhesives or screws. In other embodiments, adhesives, screws, bolts, or other fasteners may be used to fasten together the various components.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A linear LED lighting system comprising:
at least two tilted, parabolic reflecting surfaces;
a linear array of LED devices, at least some of the LED devices in the linear array substantially disposed at a focus line of at least one of the tilted, parabolic reflecting surfaces; and
a diffuser disposed adjacent to the at least two tilted, parabolic reflecting surfaces so that light exits the system through the diffuser.

2. The linear LED lighting system of claim 1 wherein the tilted, parabolic reflecting surfaces are tilted from 5 degrees to 9 degrees relative to the normal.

3. The linear LED lighting system of claim 2 wherein the tilted, parabolic reflecting surfaces are separated at the base by about 49 mm.

4. The linear LED lighting system of claim 1 wherein the tilted, parabolic reflecting surfaces are tilted from 6 degrees to 8 degrees relative to the normal.

5. The linear LED lighting system of claim 4 wherein the tilted, parabolic reflecting surfaces are separated at the base by about 39 mm.

6. The linear LED lighting system of claim 1 wherein the tilted, parabolic reflecting surfaces are tilted about 8 degrees relative to the normal.

7. The linear LED lighting system of claim 6 wherein the tilted, parabolic reflecting surfaces are separated at the base by about 30 mm.

8. The linear LED lighting system of claim 1 wherein the diffuser is connected to the parabolic reflecting surfaces by a tab and slot arrangement.

9. The linear LED lighting system of claim 1 wherein the linear array of LED devices further comprises two rows of LED devices, each row at the focus line of each of the tilted, parabolic reflecting surfaces.

10. The linear LED lighting system of claim 1 wherein the linear array of LED devices further comprises a single row of LED devices at the focus line for both of the tilted, parabolic reflecting surfaces.

11. The linear LED lighting system of claim 10 further comprising a mounting arrangement connected to the tilted, parabolic, reflecting surfaces, the mounting arrangement engageable with at least a portion of a pre-existing light fixture.

12. The linear LED lighting system of claim 11 further comprising a power supply connected to the LED devices.

13. The linear LED lighting system of claim 12 wherein the diffuser provides from 10% to 15% diffusion.

14. A solid-state lighting system comprising:
two tilted, parabolic reflecting surfaces having a common focus line;
a row of LED devices disposed substantially on the common focus line of the two tilted, parabolic reflecting surfaces; and
a diffuser adjacent to the two tilted, parabolic reflecting surfaces opposite the row of LED devices.

15. A light fixture comprising the solid-state lighting system of claim 14.

16. A light fixture comprising a plurality of the solid-state lighting systems of claim 15.

17. The light fixture of claim 15 further comprising a power supply connected to the LED devices.

18. The light fixture of claim 17 wherein the tilted, parabolic reflecting surfaces are tilted inward from 5 degrees to 9 degrees relative to the normal.

19. The light fixture of claim 18 wherein the tilted, parabolic reflecting surfaces are separated at the base by about 49 mm.

20. The light fixture of claim 17 wherein the tilted, parabolic reflecting surfaces are tilted inward from 6 degrees to 8 degrees relative to the normal.

21. The light fixture of claim 20 wherein the tilted, parabolic reflecting surfaces are separated at the base by about 39 mm.

22. The light fixture of claim 17 wherein the tilted, parabolic reflecting surfaces are tilted inward about 8 degrees relative to the normal.

23. The light fixture of claim 22 wherein the tilted, parabolic reflecting surfaces are separated at the base by about 30 mm.

24. The light fixture of claim 17 wherein the diffuser provides from 10% to 15% diffusion.

25. The light fixture of claim 24 wherein the diffuser is connected to the parabolic reflecting surfaces by a tab and slot arrangement.

26. A method of installing an LED lighting system, the method comprising:
providing a plurality of LED lighting assemblies, each LED lighting assembly including two tilted, parabolic reflecting surfaces connected to a mounting plate and having a common focus line and a row of LED devices disposed substantially on the common focus line;
directing engagement of the mounting plate with at least a portion of a pre-existing light fixture; and
directing connection of the LED devices to a power source.

27. The method of claim 26 wherein each of the LED lighting assemblies includes a power supply and the connection of the LED devices to the power source comprises connected the power supply to the power source.

28. The method of claim 26 further comprising adjusting a tilt angle of the two tilted, parabolic reflecting surfaces to a specified tilt angle from 5 degrees to 9 degrees relative to the normal.
